(19) United States
(12) Patent Application Publication
(10) Pub. No.: US 2010/0103210 A1
(43) Pub. Date: Apr. 29, 2010

(54) LIQUID DISCHARGING APPARATUS

(75) Inventor: Tomohiro SAYAMA, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/604,239

(22) Filed: Oct. 22, 2009

(30) Foreign Application Priority Data
Oct. 23, 2008 (JP) 2008-273472

(51) Int. Cl. B41J 29/38

(52) U.S. Cl. 347/10

(57) ABSTRACT

A liquid discharging apparatus includes a liquid discharging head that has nozzle groups each having a plurality of nozzles. The liquid discharging head discharges liquid from the nozzles through the operation of pressure generation elements. A first driving signal generating section generates, in a generation cycle, a first driving signal that includes a discharging pulse for discharging liquid by driving the pressure generation elements. A second driving signal generating section generates, in the generation cycle, a second driving signal that includes the discharging pulse. A controlling section selects a discharging pulse included in the first driving signal or the second driving signal based on discharging control information for controlling the discharging of the liquid and supplies the selected discharging pulse to the pressure generation elements to control the discharging of the liquid. The controlling section makes discharging-pulse selection for each nozzle group.

### BACKGROUND

1. Technical Field

The present invention generally relates to a liquid discharging apparatus such as an ink-jet printer or the like. In particular, the invention relates to a liquid discharging apparatus that is capable of controlling liquid-discharging operation with the use of a plurality of driving signals.

2. Related Art

A liquid discharging apparatus is provided with a liquid discharging head having a plurality of nozzles. Various kinds of liquid can be discharged from the nozzles of the liquid discharging head. An example of a liquid discharging apparatus is an image recording apparatus such as an ink-jet printer. An ink-jet printer is provided with an ink-jet recording head, which is an example of various kinds of liquid discharging heads. An ink-jet printer performs recording by discharging ink in the form of a liquid from the nozzles of the recording head toward a recording target medium such as a sheet of printing paper or the like. As a result of the landing of the discharged ink drops onto the surface of the liquid-discharging target object, dots are formed thereon. In this way, the ink-jet printer performs recording operation. The ink-jet recording head may be hereinafter simply referred to as a “recording head”. The ink-jet printer may be hereinafter simply referred to as a “printer”. These days, the application of such a liquid discharging apparatus is not limited to an image recording apparatus mentioned above; for example, a liquid discharging apparatus is used as, among many other types of manufacturing apparatuses, a manufacturing apparatus used for production of a color filter for a liquid crystal display device.

A printer that prints an image as explained above is provided with a driving signal generation circuit (driving signal supply portion). The driving signal generation circuit generates a driving signal that includes discharging pulses repetitively at a certain cycle (predetermined generation cycle). The discharging pulses are used for driving piezoelectric elements (pressure generation elements) to perform ink-discharging operation. The discharging pulses included in the driving signal are selectively supplied to the piezoelectric elements in accordance with pixel data expanded on the basis of print data. By this means, ink is discharged from the nozzles of the recording head. In a recording head that has a plurality of nozzle lines, a driving signal generated by a driving signal generation circuit is used as a common signal for driving piezoelectric elements corresponding to nozzles of each nozzle line. An example of such a configuration is disclosed in JP-A-2007-245475.

As an example of problems of a printer having the configuration explained above, the circuit burden of a driving signal supply portion from a driving signal generation circuit to piezoelectric elements is inevitably large when ink is discharged concurrently from the nozzles of respective nozzle lines. As the number of nozzle lines increases, so does the circuit burden of the driving signal supply portion. As the circuit burden of the driving signal supply portion increases, so does the amount of heat generated in the circuit. There is a risk that the increased heat evolution may shorten the service life of the circuit.

### SUMMARY

An advantage of some aspects of the invention is to provide a liquid discharging apparatus that is capable of effectively suppressing the generation of heat in a circuit for improved durability.

In order to address the above-identified problems without any limitation thereto, a liquid discharging apparatus according to a first aspect of the invention includes: a liquid discharging head that has a plurality of nozzle groups each of which is made up of a plurality of nozzles, the liquid discharging head being capable of discharging liquid from the nozzles through the operation of pressure generation elements; a first driving signal generating section that generates, in a predetermined generation cycle, a first driving signal that includes a predetermined discharging pulse for discharging liquid by driving the pressure generation elements; a second driving signal generating section that generates, in the predetermined generation cycle, a second driving signal that includes the predetermined discharging pulse; and a controlling section that selects a discharging pulse included in the first driving signal or the second driving signal on the basis of discharging control information for controlling the discharging of the liquid and supplies the selected discharging pulse to the pressure generation elements so as to control the discharging of the liquid, wherein the controlling section makes discharging-pulse selection for each nozzle group.

In the configuration of a liquid discharging apparatus according to the first aspect of the invention, it is preferable that the controlling section should determine the assignment of the driving signals to the pressure generation elements of the nozzle groups so that the load of a first driving signal supply portion from the first driving signal generating section to the pressure generation elements is substantially equal to the load of a second driving signal supply portion from the second driving signal generating section to the pressure generation elements. Herein, the meaning of “substantially equal” is not limited to perfect equilibrium. That is, “substantially equal” encompasses a “close-to-equal” state in which the load of the first driving signal supply portion is roughly equal to the load of the second driving signal supply portion in terms of level, magnitude, degree, and the like while tolerating some margin of unbalance (i.e., imperfect equilibrium).

In the preferred configuration of a liquid discharging apparatus described above, it is further preferable that the controlling section should calculate an expected load for each nozzle group on the basis of the discharging control information, generate driving signal selection information that indicates, for each nozzle group, which one of the first driving signal and the second driving signal should be assigned to the pressure generation elements of the nozzle group, and then add the generated driving signal selection information to the discharging control information, and the driving signals that are supplied to the pressure generation elements of the nozzle groups should be selectively determined on the basis of the driving signal selection information.

With the preferred configuration described above, the controlling section determines whether the discharging pulse(s) of the first driving signal should be supplied to the pressure generation elements of the nozzle group or the discharging pulse(s) of the second driving signal should be supplied thereto so that the load of the first driving signal supply portion is substantially equal to the load of the second driving signal supply portion. Since neither of the first driving signal supply portion and the second driving signal supply portion is burdened with an unbalanced and far heavier load, it is possible to prevent the generation of heat in the circuit of the affected driving signal supply portion. Therefore, it is possible to improve the durability of an apparatus. In addition, it is possible to reduce the size of a radiating heat sink.

In the configuration of a liquid discharging apparatus according to the first aspect of the invention, it is preferable that the first driving signal and the second driving signal should include at least one discharging pulse that has the same pulse waveform.

### BRIEF DESCRIPTION OF THE DRAWINGS

The invention will be described with reference to the accompanying drawings, wherein like numbers reference like elements.

FIG. 1 is a block diagram that schematically illustrates an example of the electric configuration of an ink-jet printer according to an exemplary embodiment of the invention.

FIG. 2 is a diagram that schematically illustrates an example of the waveform of a driving signal according to an exemplary embodiment of the invention.

FIG. 3 is a block diagram that schematically illustrates an example of the configuration of a driving signal generation circuit according to an exemplary embodiment of the invention.

FIG. 4 is a sectional view that schematically illustrates an example of the essential components of a recording head according to an exemplary embodiment of the invention.

FIG. 5 is a plan view that schematically illustrates an example of the nozzle layout of a nozzle plate according to an exemplary embodiment of the invention.

FIG. 6 is a table that shows an example of the assignment of driving signals to nozzle lines on the basis of the number of tone generations according to an exemplary embodiment of the invention.

### DESCRIPTION OF EXEMPLARY EMBODIMENTS

With reference to the accompanying drawings, the best mode for carrying out the present invention is explained below. Although various specific features are explained in the following exemplary embodiments of the invention for the purpose of disclosing preferred modes thereof, the scope of the invention is not limited to the specific embodiments described below unless any intention of restriction is explicitly shown. The invention may be modified, altered, changed, adapted, and/or improved without departing from the gist and/or spirit thereof apprehended by a person skilled in the art from explicit and implicit description given herein. In the following description, an ink-jet recording apparatus is taken as an example of a liquid discharging apparatus according to an aspect of the invention. The ink-jet recording apparatus may be hereinafter simply referred to as a “printer”.

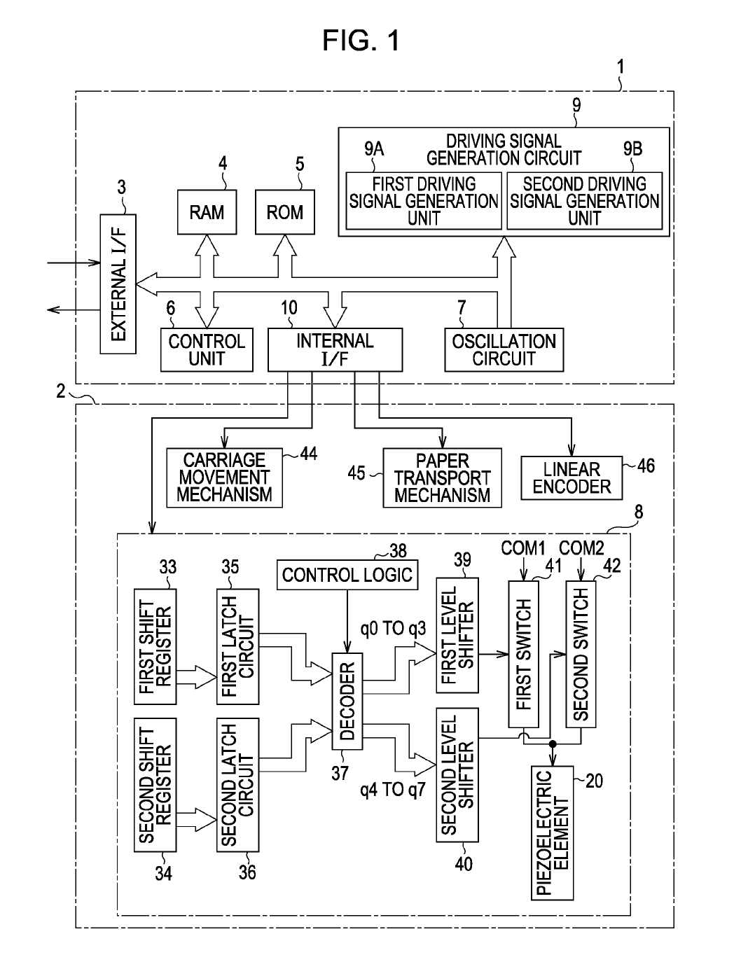

FIG. 1 is a block diagram that schematically illustrates an example of the electric configuration of a printer according to an exemplary embodiment of the invention. The illustrated printer is made up of a printer controller 1 and a print engine 2. The printer controller 1 includes an external interface (I/F) 3, a RAM 4, a ROM 5, a control unit 6, an oscillation circuit 7, a driving signal generation circuit 9, and an internal interface (I/F) 10. The external I/F 3 is used for transmitting data to and receiving data from external equipment such as a host computer, which is not illustrated in the drawing. Various kinds of data are stored in the RAM 4. Control programs and the like that are used for processing various kinds of data are stored in the ROM 5. The control unit 6 includes a CPU. The oscillation circuit 7 generates a clock signal. The driving signal generation circuit 9 generates driving signals (COM1, COM2) that are supplied to a recording head 8. The internal I/F 10 is used for transmitting pixel data SI, driving signals, and the like to the print engine 2.

The printer controller 1 receives print data from the external equipment such as a host computer or the like through the external I/F 3. For example, image data is received at the external I/F 3. The printer controller 1 outputs various state signals such as a busy signal, an acknowledge signal, and the like to the external equipment through the external I/F 3. The RAM 4 is used as a reception buffer, an inter-stage buffer, an output buffer, a work memory, and the like. Various kinds of control programs that are executed by the control unit 6, font data, graphic functions, various procedures and the like are stored in the ROM 5. The print data includes various command data in addition to image data that is to be printed out. The command data is data for commanding the printer to perform specific operation. For example, the command data includes data for commanding the feeding of paper, data that indicates paper transportation amount, and data for commanding the ejection of paper.

The control unit 6 outputs a head control signal to the recording head 8 for controlling the operation of the head 8. The control unit 6 outputs a signal generation control signal to the driving signal generation circuit 9 for causing the signal generation circuit 9 to generate the driving signal COM. The head control signal includes, for example, a transfer clock CLK, the pixel data SI, a latch signal LAT, a first change signal (i.e., a first channel signal) CH1, and a second change signal (i.e., a second channel signal) CH2. The latch signal and the change signals specify the pulse timing of the driving signals COM1 and COM2. The control signal that is used for causing the signal generation circuit 9 to generate the driving signal COM takes, for example, a DAC (Digital to Analog Conversion) value. The DAC value is information that specifies the level of a voltage that is outputted from a first driving signal generation unit 9A or a second driving signal generation unit 9B. The DAC value is updated periodically in a very short update cycle. For example, the DAC value includes a first DAC value and a second DAC value. The first DAC value is used as first signal generation information for generating the first driving signal COM1. The second DAC value is used as second signal generation information for generating the second driving signal COM2. The control unit 6 outputs either one of the first DAC value and the second DAC value to the driving signal generation circuit 9 in accordance with SP data. The SP data includes driving signal selection information according to an aspect of the invention. A more detailed explanation of the driving signal selection information will be given later. Therefore, it may be said that the DAC value is a kind of the driving signal selection information.

On the basis of the print data described above, the control unit 6 performs color conversion processing, halftone processing, dot pattern expansion processing, and the like. Specifically, in the color conversion processing, colors in an RGB color coordinate system (i.e., colorimetric system) are converted into colors in a CMYK color coordinate system. In the halftone processing, data of multiple tones is converted into data of predetermined lower tones for tone reduction. In the dot pattern expansion processing, the halftone-processed data is arrayed in a predetermined separated layout pattern for expansion into dot pattern data so that it corresponds to plural types of ink. In other words, the halftone-processed data is arrayed in the separated layout pattern so that it corresponds to plural lines of nozzles. Through the color conversion processing, the halftone processing, and the dot pattern expansion processing, the control unit 6 generates the pixel data (dot pattern data) SI that is used for controlling the discharging operation of the recording head 8. The pixel data SI is data containing information on the pixels of an image that is to be printed. The pixel data SI is an example of discharging control information according to an aspect of the invention. Herein, the term “pixels” means a dot formation area that is virtually determined on a recording target medium such as a sheet of printing paper on the surface of which ink lands. The pixel data SI that is generated on the basis of the print data contains information (i.e., a tone value) on the presence/absence of dots that are to be formed on a sheet of printing paper (or, in other words, the discharging or non-discharging of ink) and the size of a dot (or, in other words, the amount of ink discharged). The pixel data SI according to the present embodiment of the invention is a 2-bit tone value. Accordingly, there are four types in the pixel data SI, that is, data [00] that corresponds to dot omission (slight vibration), data [01] that corresponds to the formation of a small dot, data [10] that corresponds to the formation of a medium dot, and data [11] that corresponds to the formation of a large dot. Therefore, a printer according to the present embodiment of the invention is capable of forming dots in four tone levels, including dot omission.

The pixel data SI is made up of two bit data groups. Specifically, the pixel data SI is made up of a higher-order bit data group corresponding to higher-order bits of tone values and a lower-order bit data group corresponding to lower-order bits of the tone values. The control unit 6 expands the pixel data SI for every nozzle line 31, that is, for every ink type. The control unit 6 divides the data into segments each of which corresponds to one execution of the traveling of the recording head 8 in the main-scan direction, that is, a single-pass head movement. Then, the control unit 6 adds SP (Select Pattern) data to the tail of each segment of the pixel data SI. Thereafter, the control unit 6 outputs the SP-suffixed pixel data SI to the recording head 8 together with the driving signal COM. The SP data is data that associates the pixel data SI with a pulse selection pattern, which specifies a pulse(s) that should be selected among a plurality of pulses contained in the driving signal COM. A decoder 37 of the recording head 8 generates pulse selection data from the pixel data SI on the basis of the SP data. In addition, the SP data offers a driving signal selection function for selectively specifying either the first driving signal COM1 or the second driving signal COM2. The pulse(s) of the selected one of the first driving signal COM1 and the second driving signal COM2 is used. On the basis of the pixel data SI, the control unit 6 calculates expected power consumption or an expected heat value (which is a kind of an expected load according to an aspect of the invention) in accordance with the number of tone generations in each pass. Then, the control unit 6 determines which one of the two driving signals, that is, the first driving signal COM1 or the second driving signal COM2, should be assigned to piezoelectric elements 20 of the nozzle line 31. The determination is made for each nozzle line 31 on the basis of the calculated power consumption or the calculated heat value. The driving signal selection information corresponding to the determination made by the control unit 6 is contained in the SP data. A more detailed explanation thereof will be given later.

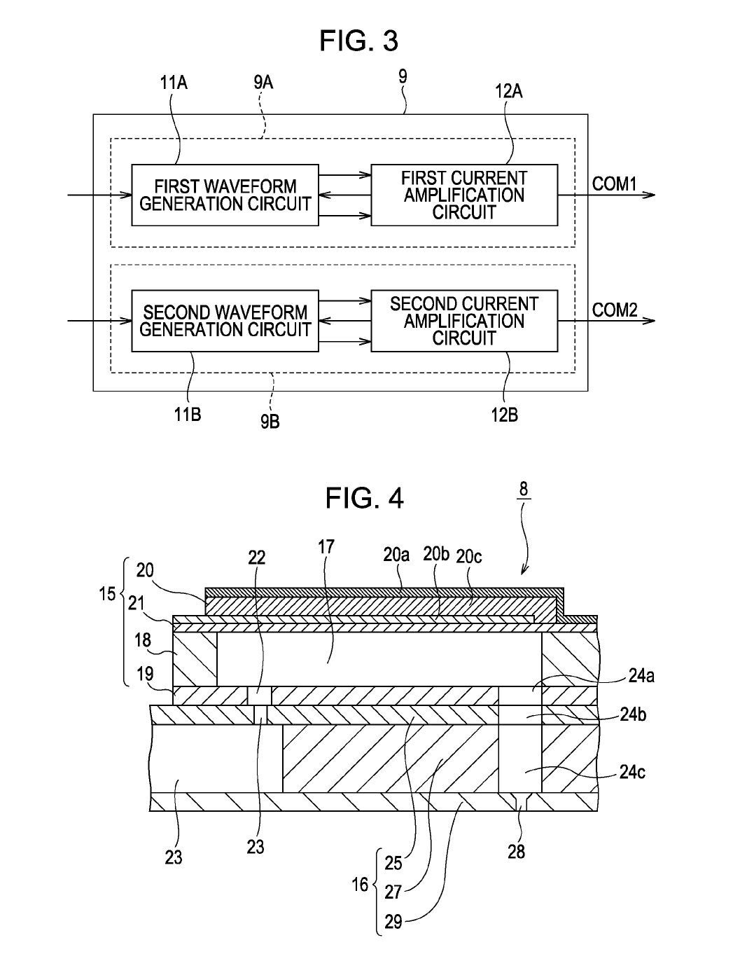

The driving signal generation circuit 9 includes the first driving signal generation unit 9A and the second driving signal generation unit 9B. The first driving signal generation unit 9A is capable of generating the first driving signal COM1. The second driving signal generation unit 9B is capable of generating the second driving signal COM2. A path that leads from the first driving signal generation unit 9A to the piezoelectric elements 20 constitutes an example of a first driving signal supply portion according to an aspect of the invention. A path that leads from the second driving signal generation unit 9B to the piezoelectric elements 20 constitutes an example of a second driving signal supply portion according to an aspect of the invention. As illustrated in FIG. 3, the first driving signal generation unit 9A includes a first waveform generation circuit 11A and a first current amplification circuit 12A. The first waveform generation circuit 11A outputs a signal that has a voltage corresponding to generation information. The first current amplification circuit 12A amplifies the current of the signal generated by the first waveform generation circuit 11A. The second driving signal generation unit 9B includes a second waveform generation circuit 11B and a second current amplification circuit 12B. The configuration of the second waveform generation circuit 11B is the same as that of the first waveform generation circuit 11A. The configuration of the second current amplification circuit 12B is the same as that of the first current amplification circuit 12A. In response to, and on the basis of, a timing signal sent from the control unit 6 and the aforementioned DAC value sent therefrom, the driving signal generation circuit 9 generates a driving signal corresponding to the driving signal selection instructions, specifically, either the first driving signal COM1 or the second driving signal COM2. The generated driving signal is sent to the recording head 8 together with the pixel data SI and the SP data.

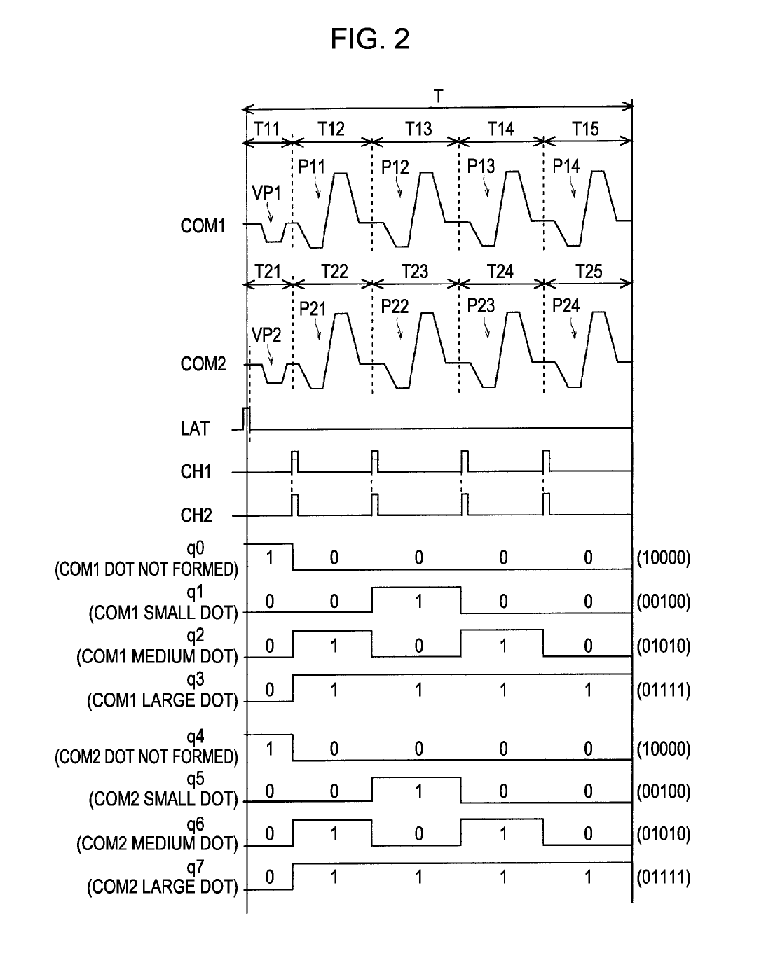

FIG. 2 is a diagram that schematically illustrates an example of the waveform of the driving signal COM generated by the driving signal generation circuit 9. The driving signal generation circuit 9 generates the first driving signal COM1 and the second driving signal COM2 illustrated in FIG. 2. Specifically, the first driving signal generation unit 9A generates the first driving signal COM1 on the basis of the first DAC value (the first generation information or first driving signal selection information). On the other hand, the second driving signal generation unit 9B generates the second driving signal COM2 on the basis of the second DAC value (the second generation information or second driving signal selection information). The driving signal COM is a signal having a series of pulses. A set of one slight vibration pulse and four discharging pulses is included in each recording period T. The pulse signal is generated repetitively with these pulses in the recording cycle T. The recording period T is an example of a predetermined generation cycle according to an aspect of the invention.

In the present embodiment of the invention, each recording period T for the first driving signal COM1 is divided in five sub-periods T11 to T15. Each sub-period is a pulse generation period during which a pulse is generated. A slight vibration pulse VP1 is generated during the sub-period T11. A first discharging pulse P11 is generated during the sub-period T12. A second discharging pulse P12 is generated during the sub-period T13. A third discharging pulse P13 is generated during the sub-period T14. Finally, a fourth discharging pulse P14 is generated during the sub-period T15. As the first driving signal COM1 has a series of pulses, so does the second driving signal COM2. A set of one slight vibration pulse and four discharging pulses is included in each recording period T. The pulse signal is generated repetitively with these pulses in the recording cycle T. Each recording period T for the second driving signal COM2 is divided in five sub-periods T21 to T25. A slight vibration pulse VP2 is generated during the sub-period T21. A first discharging pulse P21 is generated during the sub-period T22. A second discharging pulse P22 is generated during the sub-period T23. A third discharging pulse P23 is generated during the sub-period T24. Finally, a fourth discharging pulse P24 is generated during the sub-period T25.

Next, the configuration of the print engine 2 is explained below. As illustrated in FIG. 1, the print engine 2 includes the recording head 8, a carriage movement mechanism 44, a paper transport mechanism 45, a linear encoder 46, and the like. The carriage movement mechanism 44 includes a carriage, a driving motor, and the like each of which is not illustrated in the drawing. The recording head 8, which is an example of a liquid discharging head according to an aspect of the invention, is mounted on the carriage. The driving motor supplies power for moving the carriage. The motor power is transmitted to the carriage via a timing belt or the like. The recording head 8 mounted on the carriage travels in the main-scan direction as driven by the motor. An example of the driving motor is a DC motor. The paper transport mechanism 45 includes a paper-feeding motor, a paper-feeding roller, and the like. The paper transport mechanism 45 sequentially feeds sheets of recording paper onto a platen in the sub-scan direction. The recording paper is an example of a recording target medium according to an aspect of the invention, which is a liquid-discharging target object on which liquid lands. The linear encoder 46 outputs an encoder pulse, which indicates the traveling position of the recording head 8 mounted on the carriage, to the control unit 6 via the internal interface I/F 10 as information on the position thereof when viewed in the main-scan direction. On the basis of the encoder pulse sent from the linear encoder 46, the control unit 6 can obtain information on the scan position (i.e., current position) of the recording head 8.

As illustrated in FIG. 4, the recording head 8 is made up of a pressure generation unit 15 and a fluid channel unit 16. The pressure generation unit 15 is stacked on the fluid channel unit 16 and fixed thereto to form a single integrated member. The pressure generation unit 15 has a layered structure that is made up of a pressure generation chamber plate 18, a communication port plate 19, and a vibrating plate 21. A plurality of pressure generation chambers 17 is formed inside the pressure generation chamber plate 18 as demarcated compartments. Supply-side communication ports 22 and first communication ports 24a are formed through the communication port plate 19 as through holes. The piezoelectric elements 20 are provided on the diaphragm 21. The pressure generation chamber plate 18, the communication port plate 19, and the vibrating plate 21 are formed into the pressure generation unit 15 through a firing process or the like. On the other hand, the fluid channel unit 16 includes a supply port plate 25, a reservoir plate 27, and a nozzle plate 29. These plate members are bonded to one another in a layered manner to form the fluid channel unit 16. Supply ports 23 and second communication ports 24b are formed through the supply port plate 25 as through holes. A reservoir 26 is formed in the reservoir plate 27. In addition, third communication ports 24 are formed through the reservoir plate 27 as through holes. A plurality of nozzles 28 is formed through the nozzle plate 29.

The plurality of piezoelectric elements 20 is provided on an outer surface of the vibrating plate 21 that is opposite to an inner surface thereof, which faces the pressure generation chambers 17. Each of the plurality of piezoelectric elements 20 is provided for the corresponding one of the plurality of pressure generation chambers 17. In the illustrated example of the structure of the recording head 8, the piezoelectric element 20 is configured as a flexural vibrator that operates in a so-called deflection vibration mode. The piezoelectric element 20 includes a driving electrode 20a, a common electrode 20b, and a piezoelectric substance 20c. The piezoelectric substance 20c is sandwiched between the driving electrode 20a and the common electrode 20b. When a driving signal is applied to the driving electrode 20a of the piezoelectric element 20, an electric field that corresponds to a potential difference between the driving electrode 20a and the common electrode 20b is generated. The generated electric field is applied to the piezoelectric substance 20c. As a result, the deformation of the piezoelectric substance 20c occurs. The degree of deformation depends on the intensity of the electric field applied thereto. That is, the piezoelectric substance 20c contracts with a greater degree in a direction orthogonal to the electric field as the level of a voltage applied to the driving electrode 20a becomes higher, thereby causing the deflection of the vibrating plate 21 to make the capacity of the pressure generation chamber 17 smaller.

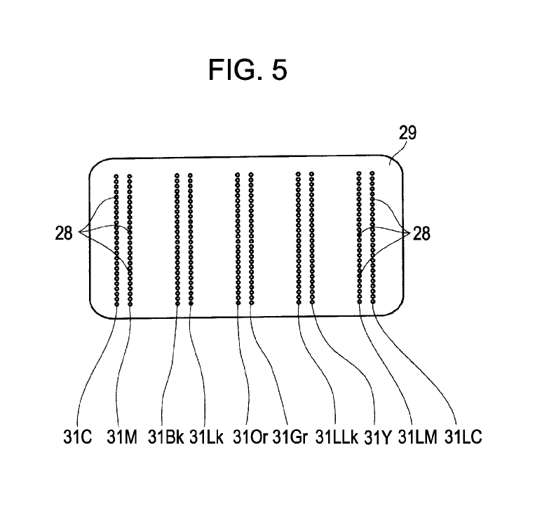

FIG. 5 is a plan view that schematically illustrates an example of the nozzle layout of the nozzle plate 29. The nozzle plate 29 is a thin plate that is made of stainless steel. The plurality of nozzle holes 28 is formed through the nozzle plate 29 with a predetermined nozzle pitch, which corresponds to dot formation density. In the configuration of the nozzle plate 29 according to the present embodiment of the invention, three hundred and sixty nozzles 28 are arrayed to form lines with 360 dpi. These nozzles 28 constitute one nozzle line 31. As illustrated in FIG. 5, ten nozzle lines are formed in parallel with one another through the nozzle plate 29. A first nozzle line 31C is formed as the leftmost one of the ten nozzle lines. A tenth nozzle line 31LC is formed as the rightmost one of the ten nozzle lines. Ink of different types (i.e., colors) can be discharged from these nozzle lines 31, respectively. That is, each nozzle line 31 corresponds to a type of ink.

For example, ink colors are assigned to these nozzle lines 31 as follows. Cyan ink is discharged from the first nozzle line 31C. Magenta ink is discharged from a second nozzle line 31M. Black ink is discharged from a third nozzle line 31Bk. Light black ink is discharged from a fourth nozzle line 31Lk. Orange ink is discharged from a fifth nozzle line 31Or. Green ink is discharged from a sixth nozzle line 31Gr. “Light-light black” ink is discharged from a seventh nozzle line 31LLk. The light-light black is a type of black that is lighter than the light black. Yellow ink is discharged from an eighth nozzle line 31Y. Light magenta ink is discharged from a ninth nozzle line 31LM. Light cyan ink is discharged from the tenth nozzle line 31LC.

In the recording head 8 that has the structure explained above, the pressure generation chamber 17 contracts or expands when the corresponding piezoelectric element 20 gets deformed. As a result of the contraction or expansion of the pressure generation chamber 17, a pressure change occurs in ink that is retained in the pressure generation chamber 17. It is possible to control the discharging of ink drops from the nozzles 28 by controlling the ink pressure inside the pressure generation chamber 17. The inner capacity of the pressure generation chamber 17 that is in a stationary state is increased as preparatory expansion before ink-discharging operation. When the pressure generation chamber 17 is pre-expanded, ink flows into the pressure generation chamber 17 through an ink supply port, which is made up of the supply port 23 and the supply-side communication port 22. After the preparatory expansion, the capacity of the pressure generation chamber 17 is decreased sharply. The supplied ink is ejected from the nozzles 28 due to the sharp contraction of the pressure generation chamber 17. In addition, a part of the ink flows back into the reservoir 26 through the ink supply port.

Next, the electric configuration of the recording head 8 is explained below. As illustrated in FIG. 1, the recording head 8 is provided with shift register circuits each of which is made up of a first shift register (SR) 33 and a second shift register 34, latch circuits each of which is made up of a first latch circuit 35 and a second latch circuit 36, the aforementioned decoder 37, a control logic 38, level shifter circuits each of which is made up of a first level shifter 39 and a second level shifter 40, switching circuits each of which is made up of a first switch (SW) 41 and a second switch 42, and the aforementioned piezoelectric elements 20. The number of each of the first shift registers 33, the second shift registers 34, the first latch circuits 35, the second latch circuits 36, the first level shifters 39, the second level shifters 40, the first switches 41, the second switches 42, and the piezoelectric elements 20 corresponds to the number of the nozzles 28. Though these electric components 33, 34, 35, 36, 39, 40, 41, 42, and 20 are provided for each nozzle 28, the components for one nozzle only is illustrated in FIG. 2. The components for the other nozzles are omitted therefrom.

The recording head 8 performs controlled ink-discharging operation on the basis of the pixel data SI sent from the printer controller 1. In the present embodiment of the invention, the higher-order bit group of the 2-bit format pixel data SI and the lower-order bit group thereof are sent to the recording head 8 in synchronization with a clock signal CLK. The higher-order bit group of the pixel data SI comes first to the recording head 8, followed by the lower-order bit group thereof. Accordingly, the higher-order bit group is first set in the second shift registers 34. After the setting of the higher-order bit group of the pixel data SI in the second shift registers 34 for all of the nozzles 28, the higher-order bit group is shifted to the first shift register 33. Concurrently with the shifting of the higher-order bit group, the lower-order bit group of the pixel data SI is set in the second shift registers 34.

The first latch circuit 35 is provided as a downstream block after the first shift register 33 in the signal processing flow of the illustrated circuitry. The second latch circuit 36 is provided as a downstream block after the second shift register 34 in the signal processing flow thereof. A latch pulse sent from the printer controller 1 is inputted into each of the first latch circuit 35 and the second latch circuit 36. Upon receiving the latch input, the first latch circuit 35 latches the higher-order bit group of the pixel data SI. The second latch circuit 36 latches the lower-order bit group of the pixel data SI. The higher-order bit group of the pixel data SI latched at the first latch circuit 35 is outputted to the decoder 37. The lower-order bit group thereof latched at the second latch circuit 36 is also outputted to the decoder 37. The decoder 37 generates pulse selection data q0 to q7 on the basis of the higher-order bit group of the pixel data SI and the lower-order bit group thereof as well as on the basis of the driving signal selection information contained in the SP data. The pulse selection data q0 to q7 is used for selecting a pulse(s) among the plurality of pulses that make up each of the first driving signal COM1 and the second driving signal COM2.

The pulse selection data according to the present embodiment of the invention is generated separately for the first driving signal COM1 and the second driving signal COM2. A first pulse selection data q0 to q3, which is generated for the first driving signal COM1, is 5-bit data that corresponds to the slight vibration pulse VP1 generated during the sub-period T11, the first discharging pulse P11 generated during the sub-period T12, the second discharging pulse P12 generated during the sub-period T13, the third discharging pulse P13 generated during the sub-period T14, and the fourth discharging pulse P14 generated during the sub-period T15. A second pulse selection data q4 to q7, which is generated for the second driving signal COM2, is 5-bit data that corresponds to the slight vibration pulse VP2 generated during the sub-period T21, the first discharging pulse P21 generated during the sub-period T22, the second discharging pulse P22 generated during the sub-period T23, the third discharging pulse P23 generated during the sub-period T24, and the fourth discharging pulse P24 generated during the sub-period T25.

In addition to the latched pixel data SI outputted from the latch circuit, a timing signal that is sent from the control logic 38 is inputted into the decoder 37. The control logic 38 generates the timing signal in synchronization with the input of a latch signal and a channel signal. The timing signal is also generated separately for the first driving signal COM1 and the second driving signal COM2. Each pulse selection data generated at the decoder 37 is inputted into the corresponding level shifter 39, 40 in accordance with the timing specified by the timing signal. The bits of the pulse selection data are inputted sequentially in a descending order. Each level shifter 39, 40 functions as a voltage amplifier. When the pulse selection data is [1], each level shifter 39, 40 outputs an electric signal that has a boosted voltage level that is high enough to drive the corresponding switch 41, 42. For example, a boosted electric signal of tens of volts or so is outputted. When the first pulse selection data is [1], an electric signal is outputted to the first switch 41. When the second pulse selection data is [1], an electric signal is outputted to the second switch 42.

The first driving signal COM1 is supplied from the first driving signal generation unit 9A to the input terminal of the first switch 41. The second driving signal COM2 is supplied from the second driving signal generation unit 9B to the input terminal of the second switch 42. The piezoelectric element 20 is connected to each of the output terminal of the first switch 41 and the output terminal of the second switch 42. That is, the first switch 41 is configured to select whether the first driving signal COM1 is supplied to the piezoelectric element 20 or not depending on its switching state. In like manner, the second switch 42 is configured to select whether the second driving signal COM2 is supplied to the piezoelectric element 20 or not depending on its switching state. Each of the first switch 41 and the second switch 42 that performs the above switching operation functions as a selective supply device.

The pulse selection data explained above controls the operation of each of the first switch 41 and the second switch 42. Throughout a time period in which the pulse selection data inputted in the first switch 41 is [1], the first switch 41 is in a conductive state. Accordingly, the first driving signal COM1 is supplied to the piezoelectric element 20 throughout this time period. In like manner, the second switch 42 is in a connected state throughout a time period in which the pulse selection data inputted in the second switch 42 is [1]. Accordingly, the second driving signal COM2 is supplied to the piezoelectric element 20 throughout this time period. Throughout a time period in which the pulse selection data inputted in the first switch 41 is [0], the first switch 41 is in a disconnected state. Accordingly, the first driving signal COM1 is not supplied to the piezoelectric element 20 throughout this time period. The second switch 42 is in a disconnected state throughout a time period in which the pulse selection data inputted in the second switch 42 is [0]. Accordingly, the second driving signal COM2 is not supplied to the piezoelectric element 20 throughout this time period. In short, each pulse corresponding to the time period in which the pulse selection data is set as [1] is selectively supplied to the piezoelectric element 20.

As a result of the switching control explained above, it is possible to apply some selected driving pulses contained in the first driving signal COM1 or the second driving signal COM2 to the piezoelectric element 20. That is, it is possible to apply a part of the pulses of the first driving signal COM1 or the second driving signal COM2 to the piezoelectric element 20 in a selective manner. In the illustrated example, the driving signal COM that is applied to the piezoelectric element 20 can be switched over from the first driving signal COM1 to the second driving signal COM2 or vice versa at a point in time at which the recording period T starts. That is, the switching of the driving signal COM can be made at the latch-pulse timing of the latch signal LAT. The pulse(s) applied to the piezoelectric element 20 can be switched over at a point in time of transition from one of the sub-period T11-T15 that make up the recording period T for the first driving signal COM1 to the next one or at a point in time of transition from one of the sub-period T21-T25 that make up the recording period T for the second driving signal COM2 to the next one. That is, the switching of the pulse(s) applied to the piezoelectric element 20 can be made at the change-pulse timing of the first change signal CH1 or at the change-pulse timing of the second change signal CH2.

Next, the dot-forming operation of the recording head 8 that has the above configuration is explained below. First, it is assumed that the pixel data SI is [11]. When the pixel data SI is [11], the decoder 37 outputs the first pulse selection data q3 for the first driving signal COM1 or the second pulse selection data q7 for the second driving signal COM2. When outputting the pulse selection data, the decoder 37 selects either the first pulse selection data q3 or the second pulse selection data q7 on the basis of the driving signal selection information contained in the SP data, which is added to the tail of the pixel data SI. The first pulse selection data q3 is outputted as a first switch control signal. The second pulse selection data q7 is outputted as a second switch control signal. In the present embodiment of the invention, when the pixel data SI is [11], the first switch control signal is set as a bit sequence of in accordance with the time series of the sub-periods T11 to T15. The second switch control signal is also set as a bit sequence of [01111] in accordance with the time series of the sub-periods T21 to T25. Therefore, as illustrated in FIG. 2, when the first pulse selection data q3 is outputted selectively, the slight vibration pulse VP1 is not applied to the piezoelectric element 20 during the sub-period T11 for the first driving signal COM1, whereas the discharging pulses P11 to P14 are applied to the piezoelectric element 20 during the sub-periods T12 to T15, respectively. When the second pulse selection data q7 is outputted selectively, the slight vibration pulse VP2 is not applied to the piezoelectric element 20 during the sub-period T21 for the second driving signal COM2, whereas the discharging pulses P21 to P24 are applied to the piezoelectric element 20 during the sub-periods T22 to T25, respectively. Accordingly, ink is ejected from the nozzle 28 four times consecutively during the recording period T. Thus, the ink whose amount corresponds to a large dot lands at a pixel area on an ink-discharging target object.

Next, it is assumed that the pixel data SI is [10]. When the pixel data SI is [10], the decoder 37 outputs the first pulse selection data q2 for the first driving signal COM1 or the second pulse selection data q6 for the second driving signal COM2. In the same manner as in the case of the pixel data [11] explained above, when outputting the pulse selection data, the decoder 37 selects either the first pulse selection data q2 or the second pulse selection data q6 on the basis of the driving signal selection information contained in the SP data. The first pulse selection data q2 is outputted as a first switch control signal. The second pulse selection data q6 is outputted as a second switch control signal. In an exemplary case of the pixel data [10] according to the present embodiment of the invention, the first switch control signal is set as a bit sequence of [01010] in accordance with the time series of the sub-periods T11 to T15. The second switch control signal is also set as a bit sequence of [01010] in accordance with the time series of the sub-periods T21 to T25. Therefore, as illustrated in FIG. 2, the application of pulses to the piezoelectric element 20 for the first pulse selection data q2 is controlled as follows. The slight vibration pulse VP1 is not applied to the piezoelectric element 20 during the sub-period T11 for the first driving signal COM1. The first discharging pulse P11 is applied to the piezoelectric element 20 during the sub-period T12. The second discharging pulse P12 is not applied to the piezoelectric element 20 during the sub-period T13. The third discharging pulse P13 is applied to the piezoelectric element 20 during the sub-period T14. The fourth discharging pulse P14 is not applied to the piezoelectric element 20 during the sub-period T15. In like manner, the application of pulses to the piezoelectric element 20 for the second pulse selection data q6 is controlled as follows. The slight vibration pulse VP2 is not applied to the piezoelectric element 20 during the sub-period T21 for the second driving signal COM2. The first discharging pulse P21 is applied to the piezoelectric element 20 during the sub-period T22. The second discharging pulse P22 is not applied to the piezoelectric element 20 during the sub-period T23. The third discharging pulse P23 is applied to the piezoelectric element 20 during the sub-period T24. The fourth discharging pulse P24 is not applied to the piezoelectric element 20 during the sub-period T25. Accordingly, ink is ejected from the nozzle 28 twice during the recording period T. Thus, the ink whose amount corresponds to a medium dot lands at a pixel area on an ink-discharging target object.

Next, it is assumed that the pixel data SI is [01]. When the pixel data SI is [01], the decoder 37 outputs the first pulse selection data q1 for the first driving signal COM1 or the second pulse selection data q5 for the second driving signal COM2. The selection is made on the basis of the driving signal selection information contained in the SP data. The first pulse selection data q1 is outputted as a first switch control signal. The second pulse selection data q5 is outputted as a second switch control signal. In an exemplary case of the pixel data [01] according to the present embodiment of the invention, the first switch control signal is set as a bit sequence of [00100] in accordance with the time series of the sub-periods T11 to T15. The second switch control signal is also set as a bit sequence of [00100] in accordance with the time series of the sub-periods T21 to T25. Therefore, as illustrated in FIG. 2, the application of pulses to the piezoelectric element 20 for the first pulse selection data q1 is controlled as follows. The slight vibration pulse VP1 is not applied to the piezoelectric element 20 during the sub-period T11 for the first driving signal COM1. The first discharging pulse P11 is not applied to the piezoelectric element 20 during the sub-period T12. The second discharging pulse P12 is applied to the piezoelectric element 20 during the sub-period T13. The third discharging pulse P13 is not applied to the piezoelectric element 20 during the sub-period T14. The fourth discharging pulse P14 is not applied to the piezoelectric element 20 during the sub-period T15. In like manner, the application of pulses to the piezoelectric element 20 for the second pulse selection data q5 is controlled as follows. The slight vibration pulse VP2 is not applied to the piezoelectric element 20 during the sub-period T21 for the second driving signal COM2. The first discharging pulse P21 is not applied to the piezoelectric element 20 during the sub-period T22. The second discharging pulse P22 is applied to the piezoelectric element 20 during the sub-period T23. The third discharging pulse P23 is not applied to the piezoelectric element 20 during the sub-period T24. The fourth discharging pulse P24 is not applied to the piezoelectric element 20 during the sub-period T25. Accordingly, ink is ejected from the nozzle 28 once during the recording period T. Thus, the ink whose amount corresponds to a small dot lands at a pixel area on an ink-discharging target object.

Next, non-recording operation in which no ink is discharged from the nozzle 28 is considered. The pixel data SI is [00] when no ink is discharged from the nozzle 28. In this case, the decoder 37 outputs the first pulse selection data q0 for the first driving signal COM1 or the second pulse selection data q4 for the second driving signal COM2. The selection is made on the basis of the driving signal selection information contained in the SP data. The first pulse selection data q0 is outputted as a first switch control signal. The second pulse selection data q4 is outputted as a second switch control signal. In this exemplary case of the pixel data [00] according to the present embodiment of the invention, the first switch control signal is set as a bit sequence of [10000] in accordance with the time series of the sub-periods T11 to T15. The second switch control signal is also set as a bit sequence of [10000] in accordance with the time series of the sub-periods T21 to T25. Therefore, as illustrated in FIG. 2, when the first pulse selection data q0 is outputted selectively, the slight vibration pulse VP1 is applied to the piezoelectric element 20 during the sub-period T11 for the first driving signal COM1, whereas the discharging pulses P11 to P14 are not applied to the piezoelectric element 20 during the sub-periods T12 to T15, respectively. When the second pulse selection data q7 is outputted selectively, the slight vibration pulse VP2 is applied to the piezoelectric element 20 during the sub-period T21 for the second driving signal COM2, whereas the discharging pulses P21 to P24 are not applied to the piezoelectric element 20 during the sub-periods T22 to T25, respectively. Therefore, pressure oscillation with a very small magnitude, which is slight enough so as not to cause the discharging of ink, occurs at the nozzle 28 in the recording period T. Because of the slight pressure vibration, ink that stays around the nozzle 28 is adequately agitated. Thus, it is possible to prevent the thickening of the ink.

As an example of problems of a printer according to related art, the circuit burden of a driving signal supply portion is inevitably large when ink is discharged concurrently from the nozzles (28) of respective nozzle lines (31). As the number of nozzle lines increases, for example, to ten lines as in the configuration of a printer according to an exemplary embodiment of the invention, so does the circuit burden of the driving signal supply portion. As the circuit burden of the driving signal supply portion increases, so does the amount of heat generated in the circuit. There is a risk that the increased heat evolution may shorten the service life of the driving circuit. In order to provide a technical solution to the above problem of related art, though the scope of the invention is not limited thereto, the control unit 6 of a printer according to the present embodiment of the invention calculates expected power consumption or an expected heat value (which is a kind of an expected load according to an aspect of the invention) in accordance with the number of tone generations (i.e., the number of tone appearances) in each pass on the basis of the pixel data SI. Then, the control unit 6 determines which one of the two (or more) driving signals should be assigned to the piezoelectric elements 20 of the nozzle line 31. The determination is made for each nozzle line 31 on the basis of the calculated power consumption or the calculated heat value, which is expected to be consumed/evolved at the driving circuit. In other words, in the present embodiment of the invention, the control unit 6 selectively assigns either the first driving signal COM1 or the second driving signal COM2 to the nozzle line 31 on the basis of the pixel data SI.

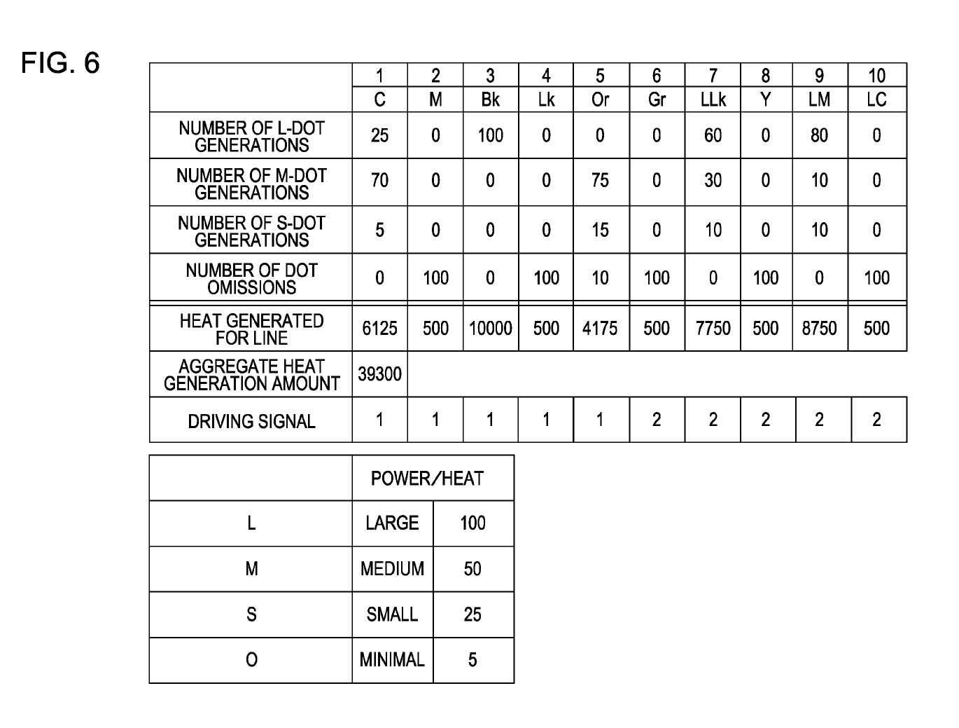

FIG. 6 is a table that shows an example of the assignment of driving signals to nozzle lines on the basis of the number of tone generations, that is, the number of tone appearances for each pass according to an exemplary embodiment of the invention. A power/heat value is specified for descriptive purposes. In this example, as illustrated in the lower part of FIG. 6, the value of power that is consumed at the driving signal supply portion or the value of heat that is generated thereat when tone-value data indicates a large dot (L) is set as one hundred. A power/heat value for tone-value data indicating a medium dot (M) is set as fifty. A power/heat value for tone-value data indicating a small dot (S) is set as twenty-five. A power/heat value for tone-value data indicating non-recording and slight vibration, which is denoted as 0 in the drawing, is set as five. The amount of heat generated for each nozzle line is calculated as a result of multiplying the above unit heat amount for each tone level by the corresponding number of tone appearances and then finding the sum thereof.

The control unit 6 acquires the number of tone appearances for each tone level for each of the plurality of nozzle lines 31 on the basis of the pixel data SI for one pass. Then, the control unit 6 calculates the amount of heat generated (or power consumed) for each nozzle line 31 in the one pass on the basis of the acquired values. The calculated value is shown as “HEAT GENERATED FOR LINE” in the drawing. Accordingly, the control unit 6 functions as a load calculator. The control unit 6 determines the assignment of the driving signals to the piezoelectric elements 20 of the nozzle lines 31 so that the load of the first driving signal supply portion is substantially equal to the load of the second driving signal supply portion. That is, the control unit 6 balances the burden of the first driving signal supply portion with that of the second driving signal supply portion to achieve load equalization or make the former as equal as possible to the latter. The following is an example of various methods for determining the assignment of the driving signals to the piezoelectric elements 20 of the nozzle lines 31. As a first step, the aggregate heat generation amount of all nozzle lines 31 is calculated. The sum of heat generated for all nozzle lines 31 is 39,300 in the illustrated example. Then, one half of the calculated sum, which is 19,650, is compared with the amount of heat generated for the first nozzle line 31C, that is, 6,125. Since the former is larger than the latter (19,650>6,125), the first driving signal COM1 is assigned to the first nozzle line 31C. Next, the amount of heat generated for the second nozzle line 31M, which is 500, is added to the amount of heat generated for the first nozzle line 31C, 6,125. Then, the one half of the calculated sum, 19,650, is compared with the result of the addition, 6,625. Since the former is still larger than the latter (19,650>6,625), the first driving signal COM1 is assigned to the second nozzle line 31M. The assignment of the driving signals to the nozzle lines 31 is continued in the same manner as above. After the addition of the amount of heat generated for the fifth nozzle line 31Or to the cumulative amount of heat generated for the first, second, third, and fourth nozzle lines, the addition result exceeds the one half of the calculated sum (21,300>19,650). Therefore, the first driving signal COM1 is assigned to each of the first nozzle line 31C, the second nozzle line 31M, the third nozzle line 31Bk, the fourth nozzle line 31Lk, and the fifth nozzle line 31Or, whereas the second driving signal COM2 is assigned to each of the remaining nozzle lines, that is, the sixth nozzle line 31Gr, the seventh nozzle line 31LLk, the eighth nozzle line 31Y, the ninth nozzle line 31LM, and the tenth nozzle line 31LC.

The assignment of the driving signals to the piezoelectric elements 20 of the nozzle lines 31 can be determined as explained above. In this example, though the load of the first driving signal supply portion is slightly heavier than the load of the second driving signal supply portion, they are roughly equalized. Since neither of the first driving signal supply portion and the second driving signal supply portion is burdened with an unbalanced and far heavier load, it is possible to prevent the generation of heat in the circuit of the affected driving signal supply portion. Therefore, it is possible to improve the durability of an apparatus. In addition, it is possible to reduce the size of a radiating heat sink.

The method of assigning the driving signals to the nozzle lines 31 is not limited to the above example. For example, the following modified method may be adopted. The first driving signal COM1 (or the second driving signal COM2) is assigned first to the nozzle line 31 that has the largest heat generation amount and to the nozzle line 31 that has the smallest heat generation amount. Next, the second driving signal COM2 (or the first driving signal COM1) is assigned to the nozzle line 31 that has the second largest heat generation amount and to the nozzle line 31 that has the second smallest heat generation amount. Next, the first driving signal COM1 (or the second driving signal COM2) is assigned to the nozzle line 31 that has the third largest heat generation amount and to the nozzle line 31 that has the third smallest heat generation amount. In like manner, the second driving signal COM2 (or the first driving signal COM1) is assigned to a pair of the nozzle lines 31 having the fourth largest heat generation amount and the fourth smallest heat generation amount, followed by the assignment of the first driving signal COM1 (or the second driving signal COM2) to a pair of the nozzle lines 31 having the fifth largest heat generation amount and the fifth smallest heat generation amount. That is, the first driving signal COM1 and the second driving signal COM2 may be assigned alternately to the nozzle lines 31 that are paired in accordance with the order of heat generation amount. As another modification example, the following method may be adopted. Heat generation amount is calculated for all possible combinations of the nozzle lines 31 and the driving signals. Then, a combination of the nozzle lines 31 and the driving signals that achieves the greatest equalization between the load of the first driving signal supply portion and the load of the second driving signal supply portion is found among all of the combinations.

The scope of the invention is not limited to the specific embodiments described above. The invention may be modified, altered, changed, adapted, and/or improved without departing from the gist and/or spirit thereof apprehended by a person skilled in the art from explicit and implicit description given herein. Such a modification and the like are also encompassed within the scope of the appended claims.

The waveform of each of the first driving signal COM1 and the second driving signal COM2 is not limited to the foregoing example. The invention can be applied to driving signals having various waveform patterns. For example, though it is explained in the foregoing exemplary embodiment of the invention that the discharging pulses included in the first driving signal COM1 are completely the same as those included in the second driving signal COM2, the scope of the invention is not limited thereto. That is, some discharging pulses included in the first driving signal COM1 may be different from discharging pulses included in the second driving signal COM2. Various modified waveforms can be adopted as long as the first driving signal COM1 and the second driving signal COM2 include at least one common discharging pulse that has the same pulse pattern. That is, there may be any pulse having a non-common pulse pattern, which is included in either one of the first driving signal COM1 and the second driving signal COM2 only. The concept of the invention can be still embodied with such a modified waveform by making selection for each nozzle group as to which one of the common same-pattern discharging pulse included in the first driving signal COM1 and the common same-pattern discharging pulse included in the second driving signal COM2 should be used. The number of driving signals is not limited to two. Three or more driving signals may be adopted as long as the driving signals are selectively assigned to nozzle groups.

In the foregoing exemplary embodiment of the invention, it is explained that the control unit 6 divides the pixel data SI into segments each of which corresponds to one execution of the traveling of the recording head 8 in the main-scan direction, that is, a single-pass head movement, and then adds the SP data to the tail of each segment of the pixel data SI. However, the scope of the invention is not limited to such an example. For example, the SP data for one image may be added to the tail of the pixel data SI for one image. In such a modified configuration, the calculation of heat generation amount as well as other processing is performed with a processing unit of one image.

The invention can be applied to various types of liquid discharging apparatuses that are capable of performing liquid-discharging control by means of a plurality of driving signals. For example, the liquid discharging apparatus may be embodied as various types of ink-jet recording apparatuses including but not limited to a plotter, a facsimile machine, and a copying machine as well as a printer explained herein. The uses/applications of the invention are not limited to recording apparatuses. For example, the liquid discharging apparatus may be embodied as display manufacturing equipment, electrode manufacturing equipment, chip manufacturing equipment, and so forth.

What is claimed is:

1. A liquid discharging apparatus comprising:
a liquid discharging head that has a plurality of nozzle groups each of which is made up of a plurality of nozzles, the liquid discharging head being capable of discharging liquid from the nozzles through the operation of pressure generation elements;
a first driving signal generating section that generates, in a predetermined generation cycle, a first driving signal that includes a predetermined discharging pulse for discharging liquid by driving the pressure generation elements;
a second driving signal generating section that generates, in the predetermined generation cycle, a second driving signal that includes the predetermined discharging pulse; and
a controlling section that selects a discharging pulse included in the first driving signal or the second driving signal on the basis of discharging control information for controlling the discharging of the liquid and supplies the selected discharging pulse to the pressure generation elements so as to control the discharging of the liquid,
wherein the controlling section makes discharging-pulse selection for each nozzle group.

2. The liquid discharging apparatus according to claim 1, wherein the controlling section determines the assignment of the driving signals to the pressure generation elements of the nozzle groups so that the load of a first driving signal supply portion from the first driving signal generating section to the pressure generation elements is substantially equal to the load of a second driving signal supply portion from the second driving signal generating section to the pressure generation elements.

3. The liquid discharging apparatus according to claim 2,
wherein the controlling section calculates an expected load for each nozzle group on the basis of the discharging control information, generates driving signal selection information that indicates, for each nozzle group, which one of the first driving signal and the second driving signal should be assigned to the pressure generation elements of the nozzle group, and then adds the generated driving signal selection information to the discharging control information, and
the driving signals that are supplied to the pressure generation elements of the nozzle groups are selectively determined on the basis of the driving signal selection information.

4. The liquid discharging apparatus according to claim 1, wherein the first driving signal and the second driving signal include at least one discharging pulse that has the same pulse waveform.
